(19) United States
(12) Patent Application Publication
(10) Pub. No.: US 2013/0237231 A1
(43) Pub. Date: Sep. 12, 2013

(54) USING ACCESS POINTS TO IDENTIFY COVERAGE HOLES

(71) Applicant: QUALCOMM INCORPORATED, San Diego, CA (US)

(72) Inventors: Sumeeth NAGARAJA, San Diego, CA (US); Yeliz TOKGOZ, San Diego, CA (US); Peerapol TINNAKORNSRISUPHAP, San Diego, CA (US); Mehmet YAVUZ, San Diego, CA (US)

(73) Assignee: QUALCOMM INCORPORATED, San Diego, CA (US)

(21) Appl. No.: 13/785,618

(22) Filed: Mar. 5, 2013

Related U.S. Application Data
(60) Provisional application No. 61/609,209, filed on Mar. 9, 2012.

(51) Int. Cl. H04W 36/30

(52) U.S. Cl. CPC H04W 36/30
USPC 455/438

(57) ABSTRACT

Coverage holes are identified and appropriate action taken in response thereto. The identification of a coverage hole may be based on, for example, measurements taken at an access point, measurement report messages from an access terminal, idle user registrations, active user handovers, or handover history. Upon identification of a coverage hole, action may be taken to mitigate (e.g., reduce or eliminate) the coverage hole and/or avoid the coverage hole. For example, in some embodiments, access point resources such as power, frequency and time are allocated accordingly. The action to be taken may depend on whether a coverage hole is noise-limited or interference-limited. In some embodiments, the manner in which handovers are conducted is modified upon identification of a coverage hole. The above actions may be performed entirely at an access point.

### CLAIM OF PRIORITY

This application claims the benefit of and priority to commonly owned U.S. Provisional Patent Application No. 61/609,209, filed Mar. 9, 2012, and assigned Attorney Docket No. 121749P1, the disclosure of which is hereby incorporated by reference herein.

### BACKGROUND

1. Field

This application relates generally to wireless communication and more specifically, but not exclusively, to identifying coverage holes.

2. Introduction

A wireless communication network may be deployed over a geographical area to provide various types of services (e.g., voice, data, multimedia services, etc.) to users within that geographical area. In a typical implementation, access points (e.g., corresponding to different macrocells) are distributed throughout a network to provide wireless connectivity for access terminals (e.g., cell phones) that are operating within the geographical area served by the network.

In practice, uniform cell coverage may not exist throughout the area served by the network. For example, there may be areas where an access terminal is not able to receive signals of sufficient signal strength from any access point in the network. These so-called coverage holes may result, for example, from the construction of a new building that interferes with signal transmissions from a previously deployed macrocell or from a poor site survey during deployment of the macrocells for the system.

In some networks, low-power access points are deployed to supplement conventional network access points (e.g., macro access points). In general, these low-power access points provides more robust coverage and higher throughput for access terminals in the vicinity of the low-power access points. For example, a low-power access point installed in a user's home or in an enterprise environment (e.g., commercial buildings) may provide voice and high speed data service for access terminals supporting cellular radio communication (e.g., CDMA, WCDMA, UMTS, LTE, etc.).

A network operator may use low-power access points to address coverage holes in the macro network. The coverage area of a low-power access point is smaller compared to the coverage area of a macro access point due to transmit power limitations of the low-power access point. Therefore, multiple low-power access points are required to cover a large region. These low-power access points are typically unmanaged and installed indoors at user premises. Consequently, a network of unmanaged, randomly deployed low-power access point may have coverage holes as well.

At some point in time, an active or idle access terminal may pass through a region where coverage holes exist, even in cases where both macro access points and low-power access points are deployed. As a result, the access terminal may experience call drops and/or packet losses due to these coverage holes. As packet losses may lead to voice artifacts, packet delays, and poor user experience, a need exists for effective techniques for eliminating coverage holes.

### SUMMARY

A summary of several sample aspects of the disclosure follows. This summary is provided for the convenience of the reader to provide a basic understanding of such aspects and does not wholly define the breadth of the disclosure. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later. For convenience, the term some aspects may be used herein to refer to a single aspect or multiple aspects of the disclosure.

The disclosure relates in some aspects to identifying coverage holes and taking action in response to the identification of the coverage holes. In some aspects, the identification of coverage holes involves identifying coverage holes within macrocell coverage and/or coverage provided by other types of cells.

The identification of a coverage hole may be based on various types of information acquired by various types of devices. In some aspects, identification of a coverage hole is based on one or more of: measurements taken at an access point using a network listen module (NLM); measurement report messages generated by an access terminal; information received during idle user registration; information received during active user handovers; or received access terminal handover history information.

Based on the above coverage hole information, appropriate action may be taken to mitigate (e.g., reduce or eliminate) the coverage hole and/or avoid the coverage hole. In some embodiments, access point resources such as power, frequency, and time can be allocated accordingly. In some embodiments, the manner in which handovers are conducted is modified.

The above actions may be performed entirely at an access point in some cases, while in other cases some of these actions are performed by another entity. For example, in some embodiments, an access point that receives signals indicative of the coverage hole may identify a coverage hole and take local action. Alternatively, in some embodiments, an access point may be instructed to take action by another entity that identified a coverage hole. This other entity may be, for example, a network entity that received information (e.g., messages) from one or more access points that, in turn, received signals indicative of a coverage hole. Upon identifying this coverage hole, the network entity may send a message to at least one access point (e.g., an access point that received the signals indicative of the coverage hole) to alter the operation of the access point(s) to address the coverage hole.

In some embodiments, an action taken upon identification of a coverage hole involves determining whether a region is noise-limited or interference-limited. Different actions may then be taken based on this determination. For example, in the event a region is noise-limited, transmit power may be increased and/or resource block allocation may be increased to improve coverage in the region. As another example, in the event a region is interference-limited, transmit power may not be increased; however, resource block allocation may be increased to improve coverage in the region.

In view of the above, in some aspects, wireless communication in accordance with the teachings herein involves: receiving signals; identifying, based on the received signals, at least one region that has inadequate radiofrequency signal quality and is near an access point; and modifying handover operations of the access point based on the identification of the at least one region having inadequate radiofrequency signal quality.

In addition, in some aspects, wireless communication in accordance with the teachings herein involves: receiving signals; identifying, based on the received signals, at least one region that has inadequate radiofrequency signal quality and is near an access point; determining, based on the received signals, whether the at least one region is noise-limited or interference-limited; and allocating at least one resource for the access point based on the determination of whether the at least one region is noise-limited or interference-limited.

### BRIEF DESCRIPTION OF THE DRAWINGS

These and other sample aspects of the disclosure will be described in the detailed description and the claims that follow, and in the accompanying drawings, wherein:

FIG. 1 is a simplified block diagram of a sample embodiment of a communication system including low-power access points;

FIG. 2 is a flowchart of several sample aspects of operations that may be performed in conjunction with taking action as a result of identifying a coverage hole;

FIG. 3 is a flowchart of several sample aspects of operations that may be performed to acquire information to identify a coverage hole;

FIG. 4 is a flowchart of several sample aspects of operations that may be performed to modify handover operations as a result of identifying a coverage hole;

FIG. 5 is a flowchart of several sample aspects of operations that may be performed to allocate a resource for an access point as a result of identifying a coverage hole;

FIG. 6 is a simplified block diagram of several sample aspects of components that may be employed in communication nodes;

FIG. 7 is a simplified diagram of a wireless communication system;

FIG. 8 is a simplified diagram of a wireless communication system including femto nodes;

FIG. 9 is a simplified diagram illustrating coverage areas for wireless communication;

FIG. 10 is a simplified block diagram of several sample aspects of communication components; and

FIGS. 11 and 12 are simplified block diagrams of several sample aspects of apparatuses configured to provide functionality relating to identifying coverage holes and taking corresponding action as taught herein.

In accordance with common practice, the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

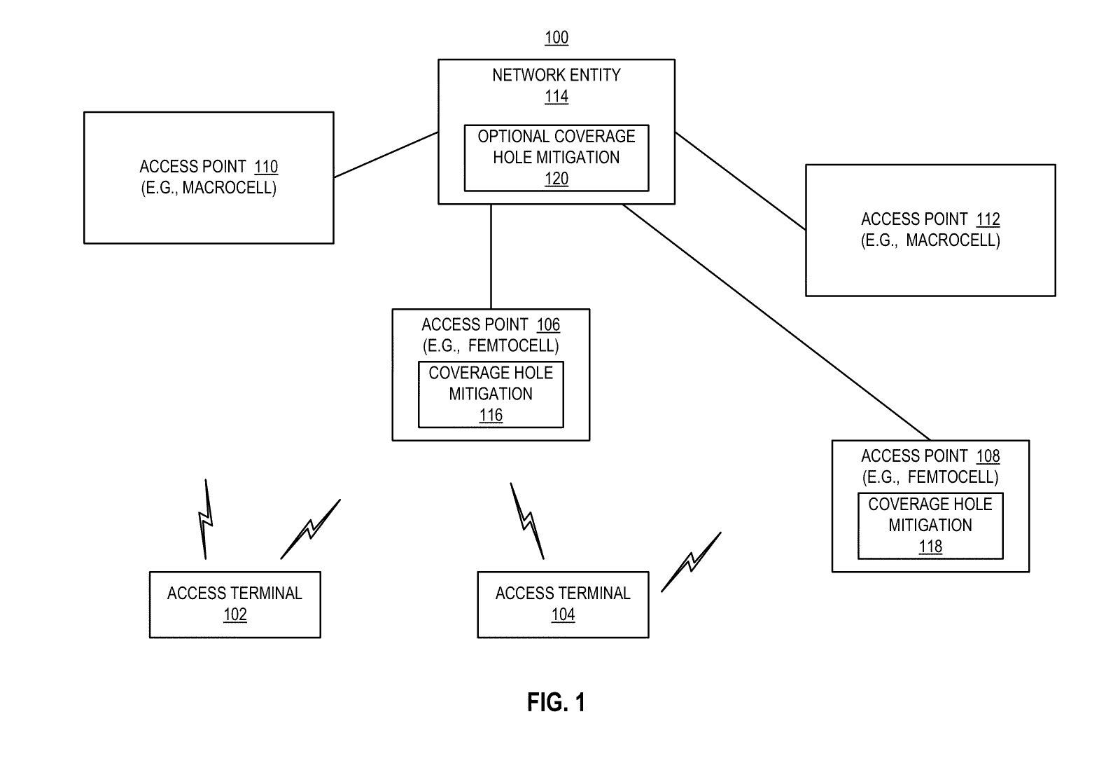

FIG. 1 illustrates several nodes of a sample communication system 100 (e.g., a portion of a communication network). For illustration purposes, various aspects of the disclosure will be described in the context of one or more access terminals, access points, and network entities that communicate with one another. It should be appreciated, however, that the teachings herein may be applicable to other types of apparatuses or other similar apparatuses that are referenced using other terminology. For example, in various implementations access points may be referred to or implemented as base stations, NodeBs, eNodeBs, femtocells, and so on, while access terminals may be referred to or implemented as user equipment (UEs), mobile stations, and so on.

Access points in the system 100 provide access to one or more services (e.g., network connectivity) for one or more access terminals (e.g., access terminals 102 and 104) that may be installed within or that may roam throughout a coverage area of the system 100. For example, at various points in time the access terminal 102 may connect to an access point 106, an access point 108, an access point 110, an access point 112, or some access point in the system 100 (not shown). Each of these access points may communicate with one or more network entities (represented, for convenience, by a network entity 114) to facilitate wide area network connectivity.

These network entities may take various forms such as, for example, one or more radio and/or core network entities. Thus, in various implementations the network entities may represent functionality such as at least one of: network management (e.g., via an operation, administration, management, and provisioning entity), call control, session management, mobility management, gateway functions, interworking functions, or some other suitable network functionality. In some aspects, mobility management relates to: keeping track of the current location of access terminals through the use of tracking areas, location areas, routing areas, or some other suitable technique; controlling paging for access terminals; and providing access control for access terminals. Also, two or more of these network entities may be co-located and/or two or more of these network entities may be distributed throughout a network.

The system 100 employs large-cell coverage via macro access points (e.g., the access points 110 and 112) and small-cell coverage via low-power access points (e.g., the access points 106 and 108). A network operator may support multiple frequencies for these macro access points and low-power access points. The low-power access points are typically deployed in a subset of these frequencies and the macro access points deployed in all or a subset of these frequencies. These subsets may or may not overlap. For example, in a co-channel deployment, low-power access points and macro access points are deployed on at least one common frequency. In a dedicated deployment, low-power access points and macro access points are deployed on different frequencies. As an example of a dedicated deployment, an operator may have three channels: f1, f2 and f3, where low-power access points are deployed in frequency f1, and macro access points are deployed in frequencies f2 and f3.

Various types of low-power access points may be employed in a given system. For example, low-power access points may be implemented as or referred to as femtocells, femto access points, femto nodes, home NodeBs (HNBs), home eNodeBs (HeNBs), access point base stations, picocells, pico nodes, or microcells. Typically, low-power access points connect to the Internet via a broadband connection (e.g., a digital subscriber line (DSL) router, a cable modem, or some other type of modem) that provides a backhaul link to a mobile operator's network. Thus, for example, low-power access points deployed in user homes provide mobile network access to one or more devices via the broadband connection.

As used herein, the term low-power access point refers to an access point having a transmit power (e.g., one or more of: maximum transmit power, instantaneous transmit power, nominal transmit power, average transmit power, or some other form of transmit power) that is less than a transmit power (e.g., as defined above) of any macro access point in a defined coverage area. In some embodiments, each low-power access point has a transmit power (e.g., as defined above) that is less than a transmit power (e.g., as defined above) of the macro access point by a relative margin (e.g., 10 dBm or more). In some embodiments, low-power access points such as femtocells may have a maximum transmit power of 20 dBm or less. In some embodiments, low-power access points such as picocells may have a maximum transmit power of 24 dBm or less. It should be appreciated, however, that these or other types of low-power access points may have a higher or lower maximum transmit power in other embodiments (e.g., up to 1 Watt in some cases, up to 10 Watts in some cases, and so on).

For convenience, low-power access points may be referred to simply as femtocells or femto access points in the discussion that follows. Thus, it should be appreciated that any discussion related to femtocells or femto access points herein may be equally applicable to low-power access points in general (e.g., to picocells, to microcells, to small cells, etc.).

Femtocells may be configured to support different types of access modes. For example, in an open access mode, a femtocell may allow any access terminal to obtain any type of service via the femtocell. In a restricted (or closed) access mode, a femtocell may only allow authorized access terminals to obtain service via the femtocell. For example, a femtocell may only allow access terminals (e.g., so called home access terminals) belonging to a certain subscriber group (e.g., a closed subscriber group (CSG)) to obtain service via the femtocell. In a hybrid access mode, alien access terminals (e.g., non-home access terminals, non-CSG access terminals) may be given limited access to the femtocell. For example, a macro access terminal that does not belong to a femtocell's CSG may be allowed to access the femtocell only if sufficient resources are available for all home access terminals currently being served by the femtocell.

In a typical deployment model, femtocells operating in open or hybrid access mode are used to provide indoor coverage and/or extended outdoor coverage. Especially for deployments that are on a dedicated carrier, even lower power level transmissions (e.g., 100 mW or less) from an indoor femtocell may provide very good coverage not only within the same building, but also at neighboring buildings, as well as outdoors. By allowing access to other users through adoption of open or hybrid access mode of operation, femtocells may provide service to an extended area and allow users within that area to be offloaded from the macro network. For a closed mode of operation, similar capabilities are provided for the authorized users of the closed femtocells. In view of the above, femtocells may be used to reduce the coverage holes in a macrocell network. However, since each femtocell has a relatively limited coverage area, coverage holes may still exist within the network.

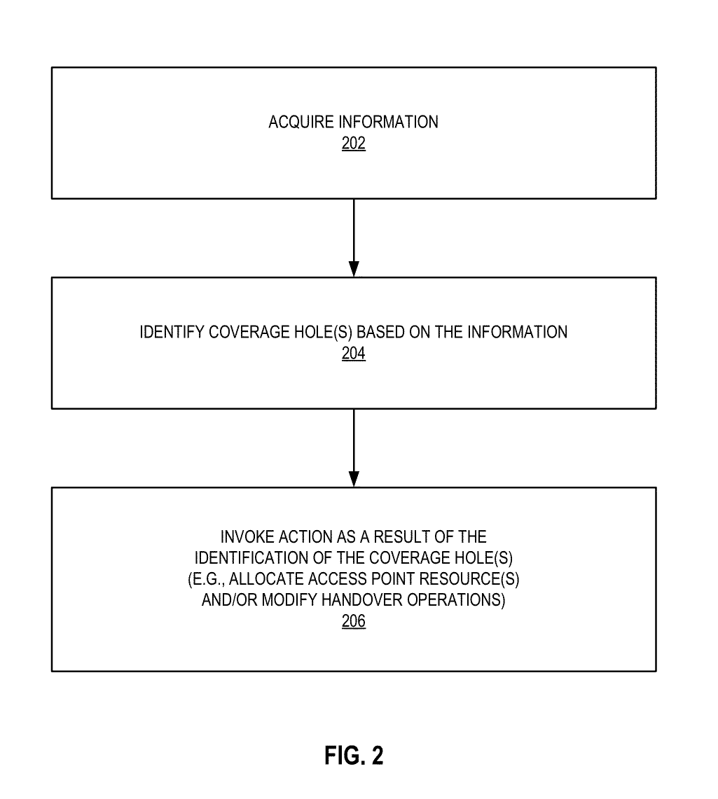

In accordance with the teachings herein, components of the system 100 include coverage hole mitigation functionality to detect coverage holes and/or take appropriate action upon detection of a coverage hole. FIG. 2 illustrates an example of these coverage hole-related operations.

For purposes of illustration, the operations of FIG. 2 (or any other operations discussed or taught herein) may be described as being performed by specific components (e.g., a femtocell). It should be appreciated, however, that these operations may be performed by other types of components (e.g., macrocells, picocells, etc.) and may be performed using a different number of components. It also should be appreciated that one or more of the operations described herein may not be employed in a given implementation.

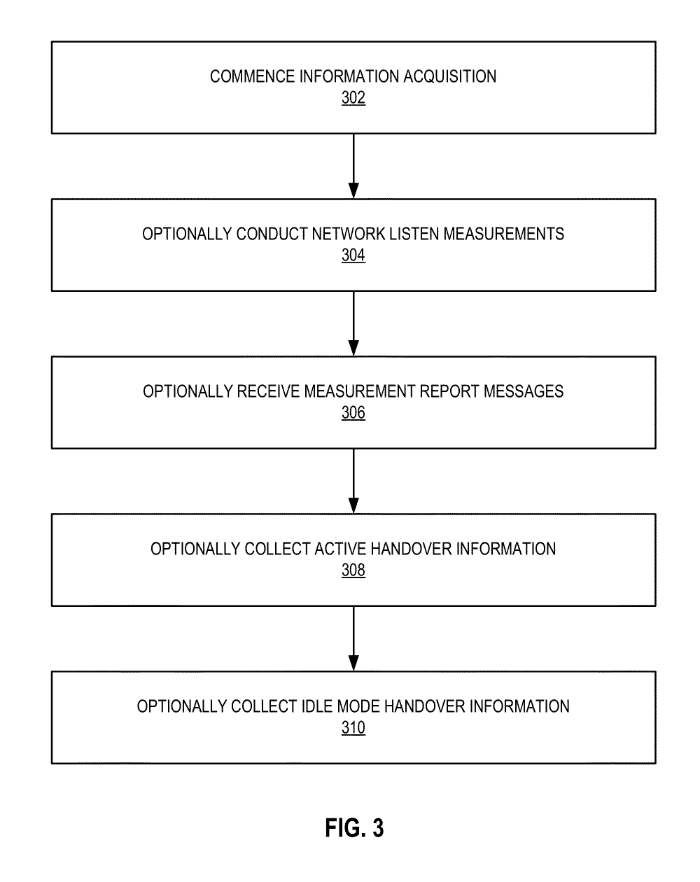

As represented by block 202, information that may be used to identify a coverage hole is acquired. This may involve, for example, acquiring one or more of: downlink signaling transmitted by cells in the vicinity of a femtocell, measurement report messages (e.g., based on one or more of: intra-frequency measurements, inter-frequency measurements, or inter-RAT measurements) sent by access terminals being served by a femtocell, handover information acquired by a femtocell, idle mode registration information acquired by a femtocell, or access terminal handover report information received by a femtocell. For example, in UMTS and LTE, this information may be obtained via a network listen module, via measurement report messages (MRMs), during handover, during idle mode registration, and via handover MRM history information elements (e.g., indicative of where and when the access terminal has been handed-over in the past). These information acquisition operations are described in more detail below in conjunction with FIG. 3.

For each type of information acquired, the timing of the acquisition may be recorded to provide information indicative of when the coverage holes occur. For example, measurements may be taken at different times of the day to determine whether coverage holes tend to come and go at certain times.

As represented by block 204, one or more coverage holes are identified based on the information acquired at block 202. For example, the presence of a coverage hole may be indicated by low signal quality in the vicinity of a femtocell. This signal quality information may be obtained, for example, via MRMs, handover messages, registration messages, etc., as discussed above. As another example, the presence of a coverage hole may be indicated by a high percentage of handovers of a certain type (e.g., if access terminals are only handed-in from a macrocell, this may indicate the presence of a femtocell coverage hole).

In some cases, the location of a coverage hole can be identified based on the information acquired at block 204. For example, location techniques may be employed to identify the location of an access terminal when it generated an MRM or was handed-over. The location of a coverage hole may then be determined relative to the location of the access terminal.

Coverage holes associated with different types of cells may be detected. For example, one or more femtocells may receive signals on a macro frequency and/or a femto frequency. Accordingly, a femtocell coverage hole and/or a macrocell coverage hole in the vicinity of the femtocell(s) may be detected.

Handover information also may be used to identify the existence and, optionally, the location of a coverage hole. For example, historical information indicative of where an access terminal has been hand-in from or handed-over to may indicate the absence of a particular type of cell in a given region. This historical information may be obtained, for example, by monitoring handover operations at a femtocell or from handover IEs received by the femtocell.

As represented by block 206, at least one action is invoked as a result of the identification of the coverage hole(s) at block 204.

In some implementations, one or more resources of a femtocell may be allocated in a manner that reduces the coverage hole and/or causes access terminals in the vicinity of the femtocell to avoid the coverage hole. For example, a femtocell may be reconfigured to transmit at a higher power level (e.g., up to maximum transmit power) to mitigate the coverage hole. In some embodiments (e.g., an LTE system), additional resource blocks may be allocated at the access point to enhance coverage in the vicinity of the femtocell. These resource blocks may comprise, for example, a frequency block and/or a time block.

As another example, handover operations of a femtocell may be modified to prevent access terminals that are handed-off by the femtocell from being adversely affected by the coverage hole. For example, if a macrocell coverage hole is detected, preference may be given to hand-out users to other femtocells. As another example, if a femtocell coverage hole is detected, preference may be given to hand-out users to macrocells.

The operations of FIG. 2 (as well as other operations described herein) may be performed by different entities in different embodiments. In the example of FIG. 1, the access points 106 and 108 (e.g., low-power access points such a femtocells) are depicted as employing coverage hole mitigation components 116 and 118, respectively. In addition, the network entity 114 is depicted as optionally employing coverage hole mitigation component 120.

In some implementations, an access point performs all identification and action operations locally. For example, the coverage hole mitigation component 116 may acquire information needed to identify a coverage hole (receive signals from other access points, receive measurement reports from access terminals, etc.), determine whether a coverage hole exists, initiate appropriate action if a coverage hole exists, and perform the action (e.g., adjust a local parameter).

In other implementations, a network entity and one or more access points may cooperate to identify coverage holes and take appropriate action. For example, the coverage hole mitigation components 116 and 118 may acquire information needed to identify a coverage hole and then pass that information to the coverage hole mitigation component 120. In this case, the coverage hole mitigation component 120 determines whether a coverage hole exists based on this received information. In a first scenario, the coverage hole mitigation component 120 may then initiate appropriate action if a coverage hole exists. In a second scenario, the coverage hole mitigation component 120 simply notifies the coverage hole mitigation components 116 and 118 of the coverage hole.

As an example of the first scenario, the coverage hole mitigation component 120 may modify at least one parameter used by the access points 106 and 108 (e.g., a resource parameter and/or a handover parameter) and send the modified parameter(s) to the access points 106 and 108. Upon receipt of the parameter(s) from the coverage hole mitigation component 120, each coverage hole mitigation component 116 and 118 uses the updated parameter(s) for subsequent operations (e.g., transmissions, handovers, etc.).

As an example of the second scenario, upon receipt of a coverage hole indication from the coverage hole mitigation component 120, each coverage hole mitigation component 116 and 118 may modify at least one local parameter (e.g., a resource parameter and/or a handover parameter). Each coverage hole mitigation component 116 and 118 may then use the modified parameter(s) for subsequent operations (e.g., transmissions, handovers, etc.).

Referring now to FIG. 3, commencing at block 302, several of the information acquisition operations mentioned above will be treated in more detail. As indicated in FIG. 3, each operation is optional in the sense that any one or any set of these operations may be employed to acquire information that is used to identify a coverage hole. Also, although these operations are listed in a particular order, in practice, two or more of these operations may be performed in different order and/or concurrently. For purposes of illustration, the information acquisition operations will be described in the context of an access point (e.g., a femtocell) that acquires the information.

As represented by block 304, in some embodiments, an access point will include a network listen module that measures downlink (forward link) signals. Accordingly, a network listen module (e.g., at first femtocell location) may be used to measure signals from other femtocells and/or from macrocells on all frequencies of interest. The measured signal may be characterized, for example, by received signal quality (e.g., signal strength) information such as received signal code power (RSCP), common pilot channel (CPICH) E_{C}/I₀, E_{CP}/I₀, and so on.

As represented by block 306, an access point may receive information from its active access terminals. For active calls originating on an access point, the access point may request periodic measurement reports on all frequencies from the access terminal. Here, the access terminal may measure and report detected cells on a co-channel. In addition, the access terminal may measure and report detected cells on other frequencies. Such an inter-frequency search may be conducted, for example, according to a neighbor cell list (NCL) sent to the access terminal by the access point, where the NCL specifies the cells and frequencies for which a search is to be conducted. Each of these measurement reports will typically include information that identifies the detected cells (e.g., identifiers such as a primary scrambling code (PSC), etc.) and indicates the received signal quality from each detected cell as measured by the access terminal The received signal quality may comprise, for example, received signal strength information (e.g., RSCP, CPICH E_{C}/I₀, E_{CP}/I₀, etc.).

As represented by block 308, an access point also may acquire information as a result of active call handovers. For example, a handover message may indicate the cells seen by an access terminal (and corresponding received signal quality for those cells) at the time of handover. Accordingly, similar to the use of MRM information discussed herein (e.g., at block 404 below), an access point may identify the existence of a coverage hole and, optionally, the location of a coverage hole based on this information.

If active hand-in from macrocell to femtocell is supported, a femtocell may determine whether users are arriving only (or substantially only) from macrocells. If so, this indicates that there is likely a femtocell coverage hole. The femtocell then uses the information from the handover message to identify the femtocell coverage hole.

For an active handover from a femtocell to a femtocell, the target femtocell may use the information from the handover message to determine femtocell coverage. Here, a femtocell may determine whether users are arriving only (or substantially only) from femtocells. If so, this indicates that there is likely a macrocell coverage hole.

As represented by block 310, an access point also may acquire information as a result of idle mode registrations by access terminals. In this case, the access point may request a measurement report from each registering user (e.g., user access terminal).

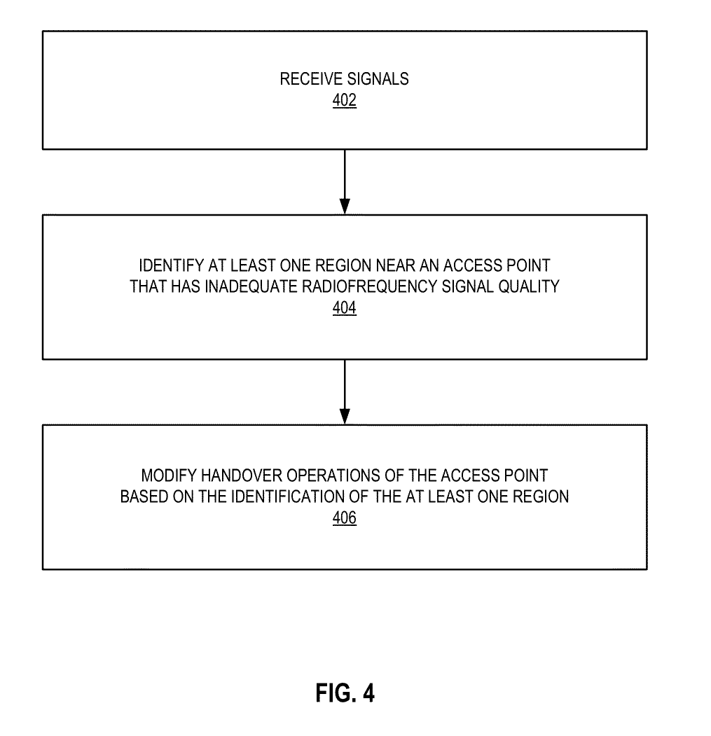

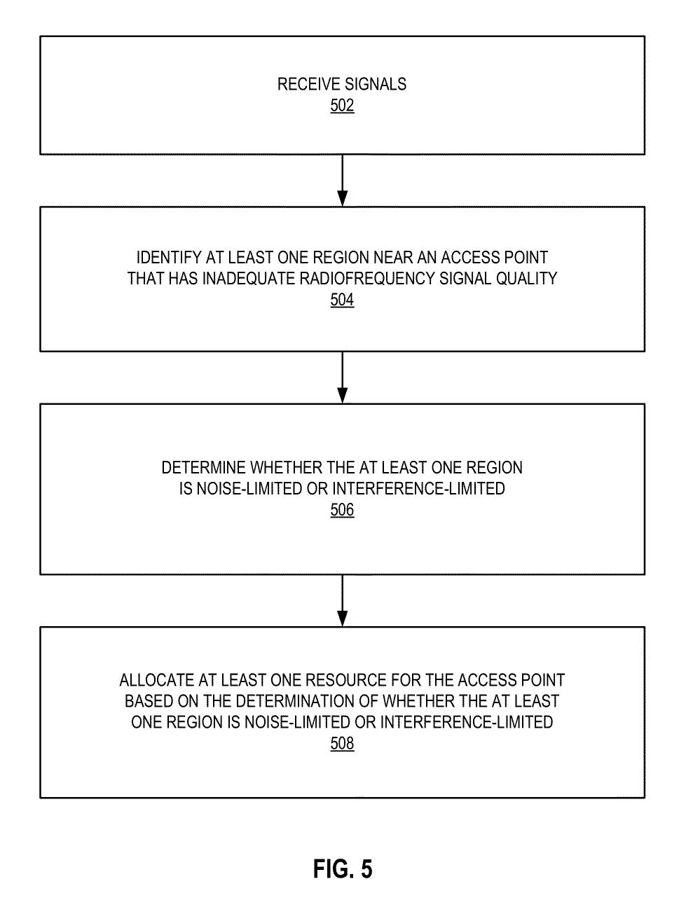

With the above in mind, operations relating to identifying coverage holes and taking action thereon will be described in more detail in conjunction with FIGS. 4 and 5.

FIG. 4 illustrates sample operations for modifying handover operations of an access point to address an identified coverage hole.

As represented by block 402, signals are received that provide information that is indicative of whether at least one coverage hole exists. The signals may take various forms.

In some cases, the signals are received as a result of network listen measurements conducted by an access point. Thus, measured signal values (e.g., signal quality) may be derived from the received signals here.

In some cases, the signals comprise a plurality of measurement report messages. These measurement report messages may originate, for example, from idle access terminals or connected mode access terminals.

In some cases, the signals comprise a plurality of handover messages. These handover messages may comprise, for example, measurement report messages sent from a source cell to a target cell, or information elements (IEs) containing access terminal history information.

The above signals may be received in various ways. In some cases, signals are received over-the-air by an entity. For example, a femtocell may receive RF signals from nearby cells and/or access terminals. In some cases, signals are received via messaging by an entity. For example, a femtocell or network entity may receive messages from neighbor cells via the backhaul.

As mentioned above, the signals may be received by different entities in different embodiments. In some implementations, these signals are received by the entity (e.g., a femtocell) that is controlled to address the detection of a coverage hole. In some implementations, these signals are received by an entity (e.g., a network entity) that controls one or more access points to address to the detection of a coverage hole.

Received signals may be associated with one or more frequencies (e.g., a femtocell carrier and macrocell carriers). Hence, corresponding regions of inadequate radiofrequency (RF) signal quality may be associated with corresponding frequencies. Consequently, the received signals may be used to identify coverage holes associated with different frequencies in some cases. For example, the network listen measurements may be conducted on different frequencies. In addition, an access terminal may conduct measurements on different frequencies and report the measurements for each frequency. Also, access terminals may be handed-over from different frequencies. Hence, the measurement reports associated with these handovers will include information from different frequencies.

As represented by block 404 of FIG. 4, based on the received signals, at least one region near an access point that has inadequate RF signal quality is identified. For example, the received signals (e.g., the signals themselves or information in received messages) may be compared to one or more thresholds to determine whether the signal quality is acceptable. In a typical case, a determination is made as to whether a signal quality measurement (e.g., a metric based on multiple signal quality measurements) is less than or equal to a threshold. If so, it may be assumed that a coverage hole exists on one or more frequencies. For example, all acquired RSCP values may be averaged and, if the average is less than −120 dBm, a coverage hole may be indicated. As another example, if a certain percentage (e.g., 90%) of the acquired signal quality values are below a threshold value, a coverage hole may be indicated.

In some implementations, the identification of a coverage hole (e.g., the identification of a region with inadequate RF signal quality) involves determining not only the existence of the coverage hole, but also a location of the coverage hole. For example, a path loss-based triangulation technique may be employed to estimate the location of the access terminal when the access terminal conducted a measurement included in a measurement report. Here, information from the measurement report such as cell identifiers along with associated path loss information (e.g., derived from the received signal strengths in the report) may be used in conjunction with the known locations of the corresponding cells to estimate the location of the access terminal.

In some aspects, a so-called “fingerprinting” technique may be used whereby different sets of signal strength (or path loss) and cell identifier information are associated with different locations in a database. Thus, when an access terminal reports its signal strength and neighbor cell information, that “fingerprint” is compared with the “fingerprints” stored in the database to determine (e.g., estimate) the location of the access terminal.

Also, based on knowledge of the locations of the neighbor cells and based on the received signal strengths measured by an access terminal, the approximate location of a coverage hole relative to the location of the access terminal may be identified. For example, it may be determined that the center of a coverage hole lies a certain direction (e.g., 90 degrees, 120 degrees, etc.) from the access terminal and is a certain distance (e.g., path loss) from the access terminal.

Location information obtained from access terminal reports may be collected over time to determine, to some degree of certainty, the location of a coverage hole. For example, all of the signal quality information corresponding to a given location reported over time (e.g., by one or more access terminals) may be binned to obtain a more accurate indication of whether a coverage hole exists at that location. As discussed herein, this information may be correlated with time in an attempt to determine whether a coverage hole tends to appear at certain times.

In some aspects, the operations of block 404 depend on the type of signal that is received at block 402. In a case where the received signals are obtained via network listen measurements, the identification of a region having inadequate radiofrequency signal quality may comprise determining that measured signal quality corresponding to the received signals is less than or equal to at least one threshold signal quality. In a case where the received signals comprise measurement report messages, the identification of a region having inadequate radiofrequency signal quality may comprise: identifying the region based on the measurement report messages, and determining that measured signal quality included in the measurement report messages are less than or equal to at least one threshold signal quality. In a case where the received signals comprise idle mode registration messages, the identification of a region having inadequate radiofrequency signal quality may comprise: identifying the at least one region based on the idle mode registration messages, and determining that measured signal quality indications included in the idle mode registration messages are less than or equal to at least one threshold signal strength. In a case where the received signals comprise handover messages, the identification of a region having inadequate radiofrequency signal quality may comprise: identifying the region based on the handover messages, identifying a type of handover associated with the handover messages; and determining that a quantity of the handovers of the identified type over a defined period of time is greater than or equal to at least one threshold quantity. The type of handover may include, for example, a femtocell to femtocell handover or a macrocell to femtocell handover. The signal quality discussed above may comprise: signal strength, CPICH E_{C}/I₀, RSSI, or some other suitable quality metric.

As represented by block 406, based on the identification of the at least one region having inadequate radiofrequency signal quality, handover operations of the access point are modified. The modification of handover operations may take various forms.

In some embodiments, the modification of handover operations comprises adjusting at least one handover parameter. The at least one handover parameter may comprise, for example, at least one cell individual offset (CIO) parameter and/or at least one hysteresis (Hyst) parameter.

In some embodiments, the modification of handover operations comprises adjusting a handover preference to increase a likelihood that an access terminal will not be handed-out. For example, if a nearby coverage hole in a macrocell is detected, the access point may try to keep access terminals from being handed-out to the macrocell (e.g., to prevent the access terminal from running into the coverage hole shortly after hand-out).

In some embodiments, the modification of handover operations comprises adjusting a handover preference to increase a likelihood that handovers will be made to a specific type of cell (e.g., macrocell or femtocell). For example, if a macrocell coverage hole is identified (e.g., based on a high percentage of femtocell to femtocell handovers), the modification of handover operations may comprise adjusting a handover preference to increase a likelihood that handovers will be made to femtocells. Conversely, if a femtocell coverage hole is identified (e.g., based on a high percentage of macrocell to femtocell handovers), the modification of handover operations may comprise adjusting a handover preference to increase a likelihood that handovers will be made to macrocells.

Various types of parameters may be adjusted to achieve a desired result. For example, since CIO is a cell-specific parameter (e.g., a corresponding CIO value is associated with each PSC), CIO values associated with macrocells may be adjusted in a different manner than CIO values associated with femtocells. In this way, a handover preference toward one of these cell types may be achieved. As another example, since Hyst may be a frequency-specific parameter (e.g., a corresponding Hyst value is associated with each carrier), Hyst values associated with macro carriers may be adjusted in a different manner than Hyst values associated with femtocell carriers, if applicable.

In some embodiments, the modification of handover operations comprises disabling measurement operations for at least one frequency. For example, if a macrocell coverage hole is identified, the access point may temporarily suspend requests for inter-frequency measurement reports on macro frequencies. In this way, hand-outs to the macrocell may be temporarily limited or halted.

In some embodiments, the modification of handover operations is based on the current location of an access terminal. For example, one set of handover parameters may be used if the access terminal is near a coverage hole (e.g., to limit hand-out), while another set of handover parameters may be used if the access terminal is further away from the coverage hole (e.g., to facilitate easier hand-out).

FIG. 5 illustrates sample operations that are performed in some embodiments to address an identified coverage hole by allocating resources (e.g., additional or new resources) for an access point. The operations of blocks 502 and 504 may be similar to the operations of blocks 402 and 404. Hence, these operations will not be treated here.

As represented by block 506, a determination is made as to whether the at least one region identified at block 504 is noise-limited or interference-limited. This determination may be made, for example, to determine whether the inadequate signal quality (e.g., low E_{CP}/I₀) at the regions(s) is a due to a lack of coverage or due to interference. As discussed below, it may be desirable to take different action at an access point depending on whether a region is noise-limited or interference-limited.

In some aspects, a determination that a region is noise-limited may involve determining whether the signal quality at the region is dominated by noise. Such a determination may serve to indicate a lack of coverage in the region.

In contrast, a determination that a region is interference-limited may involve determining whether the signal quality at the region is dominated by interference. It follows then that this determination may serve to indicate high interference in the region.

In some aspects, a determination as to whether a region is noise-limited or interference-limited may involve comparing signal information with a thermal noise floor. For example, a determination may be made as to whether measured interference (e.g., I₀) in the region is substantially equal to (e.g., with 3% of) a thermal noise floor (e.g., N₀). As another example, a determination may be made as to whether measured signal quality (e.g., RSSI) in the region is substantially equal to the thermal noise floor. Thus, in some aspects, a determination of whether at least one region is noise-limited or interference-limited comprises determining whether a total received signal strength associated with received signals is substantially equal to a thermal noise floor.

The above information may be obtained from measurement reports or other messages. For example, an MRM may report one or more of RSCP, E_{CP}/I₀, or RSSI measured by an access terminal. Thus, RSSI and/or I₀ may be acquired. A specific example follows. In WCDMA with a 5 MHz spectrum, N₀ may be −100 dBm. In one sample implementation, a noise-limited region may be indicated by an RSSI in the range of −98 to −100 dBm. Thus, an interference-limited region may be indicated by an RSSI of −97 dBm or higher. In another sample implementation, a noise-limited region may be indicated by an RSSI equal to the thermal noise floor (e.g., −100 dBm). Thus, in this case, an interference-limited region may be indicated by an RSSI of −99 dBm or higher.

As represented by block 508, based on the determination as to whether the at least one region is noise-limited or interference-limited, at least one resource for the access point is allocated. Here, different actions may be taken based on whether a region is noise-limited or interference-limited. For example, if a region is interference-limited, resource may be controlled in a manner that reduces interference or prevents an increase in interference. As mentioned above, this allocation operation may be performed by the access point and/or by another entity (e.g., that sends a message instructing the access point to allocate at least one resource).

In some cases, the allocation of the at least one resource comprises adjusting a transmit power of the access point. For example, the allocation of the at least one resource may comprise adjusting a transmit power of the access point if the at least one region is noise-limited. As a specific example, the current (or maximum allowed) transmit power of at least one access point in the region(s) may be increased to provide better coverage in the region(s).

In some cases, the allocation of the at least one resource comprises adjusting allocation of at least one resource block (e.g., at least one frequency block and/or at least one time block) for the access point. For example, the allocation of the at least one resource may comprise adjusting allocation of at least one resource block for the access point if the at least one region is noise-limited. In this way, the availability of resources in the region may be improved. As another example, the allocation of the at least one resource may comprise, if the at least one region is interference-limited, adjusting allocation of at least one resource block for the access point without increasing transmit power of the access point. As mentioned above, for an interference-limited region, the action taken may be tailored to prevent an increase in interference.

In some deployments, regions of inadequate RF signal quality are identified on multiple frequencies. That is, at least one region may be associated with one frequency, at least one other region may be associated with another frequency, and so on. In this case, the at least one resource may be allocated for transmissions by the access point on the plurality of frequencies (e.g., the transmit power for different frequencies may be adjusted).

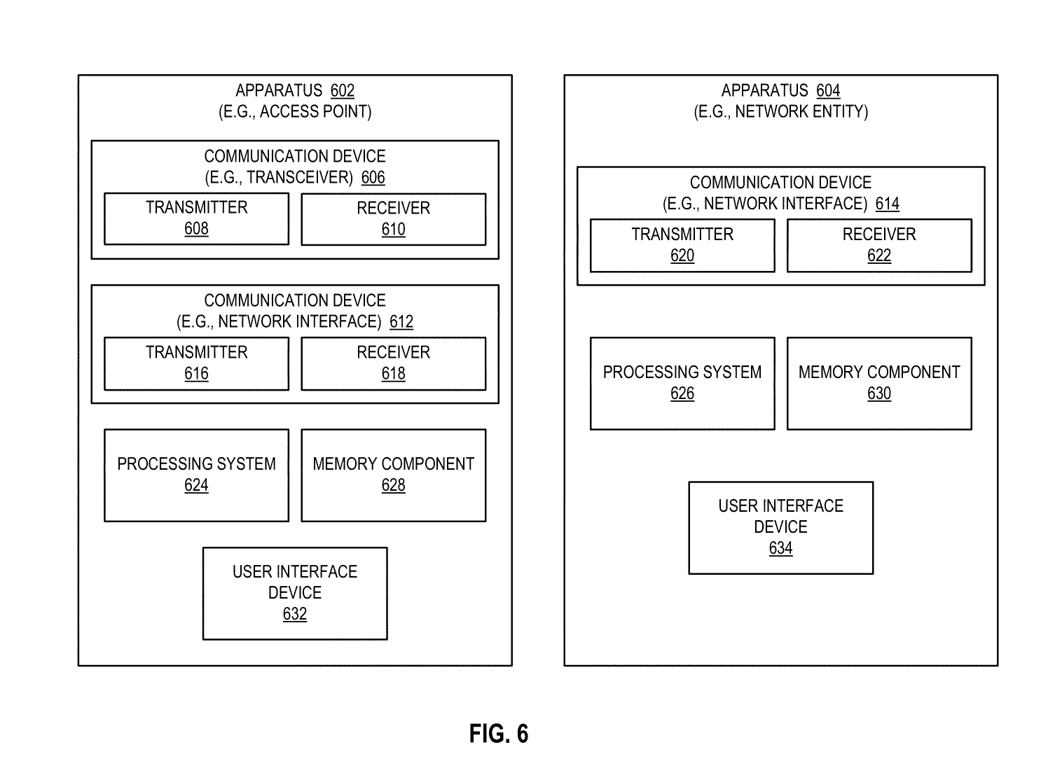

FIG. 6 illustrates several sample components (represented by corresponding blocks) that may be incorporated into an apparatus 602 and an apparatus 604 (e.g., corresponding to the access point 106 and the network entity 114, respectively, of FIG. 1) to perform coverage hole-related operations as taught herein. It should be appreciated that these components may be implemented in different types of apparatuses in different implementations (e.g., in an ASIC, in a system on a chip (SoC), etc.). The described components also may be incorporated into other nodes in a communication system. For example, other apparatuses in a system may include components similar to those described for the apparatus 602 to provide similar functionality. Also, a given apparatus may contain one or more of the described components. For example, an apparatus may include multiple transceiver components that enable the apparatus to operate on multiple carriers and/or communicate via different technologies.

The apparatus 602 includes at least one wireless communication device (represented by the communication device 606) for communicating with other nodes via at least one designated radio access technology. The wireless communication device 606 includes at least one transmitter (represented by the transmitter 608) for sending signals (e.g., messages, indications, information, and so on) and at least one receiver (represented by the receiver 610) for receiving signals (e.g., messages, indications, information, and so on). A transmitter and a receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. In some embodiments, a wireless communication device (e.g., one of multiple wireless communication devices) of the apparatus 602 comprises a network listen module.

The apparatuses 602 and 604 each include at least one communication device (represented by the communication devices 612 and 614, respectively) for communicating with other nodes. For example, each communication device 612 and 614 may comprise a network interface that is configured to communicate with one or more network entities via a wire-based or wireless backhaul. In some aspects, each communication device 612 and 614 may be implemented as a transceiver configured to support wire-based or wireless signal communication. This communication may involve, for example, sending and receiving: messages, parameters, other types of information, and so on. Accordingly, in the example of FIG. 6, the communication device 612 is shown as comprising a transmitter 616 and a receiver 618, while the communication device 614 is shown as comprising a transmitter 620 and a receiver 622.

The apparatuses 602 and 604 also include other components that may be used in conjunction with coverage hole-related operations as taught herein. The apparatus 602 includes a processing system 624 for providing functionality relating to identifying and acting on coverage holes and for providing other processing functionality. For example, the processing system may perform one or more of: identifying at least one region that has inadequate radiofrequency signal quality and is near an access point, modifying handover operations of the access point, determining whether the at least one region is noise-limited or interference-limited, or allocating at least one resource for the access point. Similarly, the apparatus 604 includes a processing system 626 for providing functionality relating to identifying and acting on coverage holes and for providing other processing functionality (e.g., as listed above). The apparatuses 602 and 604 include memory components 628 and 630 (e.g., each including a memory device), respectively, for maintaining information (e.g., information, thresholds, parameters, and so on). In addition, the apparatuses 602 and 604 include user interface devices 632 and 634, respectively, for providing indications (e.g., audible and/or visual indications) to a user and/or for receiving user input (e.g., upon user actuation of a sensing device such a keypad, a touch screen, a microphone, and so on).

For convenience, the apparatuses 602 and 604 are shown in FIG. 6 as including components that may be used in the various examples described herein. In practice, the illustrated blocks may have different functionality in different implementations. For example, in some implementations, the functionality of the block 624 may be different in an embodiment implemented in accordance with FIG. 4 as compared to an embodiment implemented in accordance with FIG. 5.

The components of FIG. 6 may be implemented in various ways. In some implementations, the components of FIG. 6 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 606, 612, 624, 628, and 632 may be implemented by processor and memory component(s) of the apparatus 602 (e.g., by execution of appropriate code and/or by appropriate configuration of processor components). Similarly, some or all of the functionality represented by blocks 614, 626, 630, and 634 may be implemented by processor and memory component(s) of the apparatus 604 (e.g., by execution of appropriate code and/or by appropriate configuration of processor components).

As discussed above, in some aspects the teachings herein may be employed in a network that includes macro scale coverage (e.g., a large area cellular network such as a 3G network, typically referred to as a macrocell network or a WAN) and smaller scale coverage (e.g., a residence-based or building-based network environment, typically referred to as a LAN). As an access terminal (AT) moves through such a network, the access terminal may be served in certain locations by access points that provide macro coverage while the access terminal may be served at other locations by access points that provide smaller scale coverage. In some aspects, the smaller coverage nodes may be used to provide incremental capacity growth, in-building coverage, and different services (e.g., for a more robust user experience).

In the description herein, a node (e.g., an access point) that provides coverage over a relatively large area may be referred to as a macro access point while a node that provides coverage over a relatively small area (e.g., a residence) may be referred to as a femto access point. It should be appreciated that the teachings herein may be applicable to nodes associated with other types of coverage areas. For example, a pico access point may provide coverage (e.g., coverage within a commercial building) over an area that is smaller than a macro area and larger than a femto area. In various applications, other terminology may be used to reference a macro access point, a femto access point, or other access point-type nodes. For example, a macro access point may be configured or referred to as an access node, base station, access point, eNodeB, macrocell, and so on. Also, a femto access point may be configured or referred to as a Home NodeB, Home eNodeB, access point base station, femtocell, and so on. In some implementations, a node may be associated with (e.g., referred to as or divided into) one or more cells or sectors. A cell or sector associated with a macro access point, a femto access point, or a pico access point may be referred to as a macrocell, a femtocell, or a picocell, respectively.

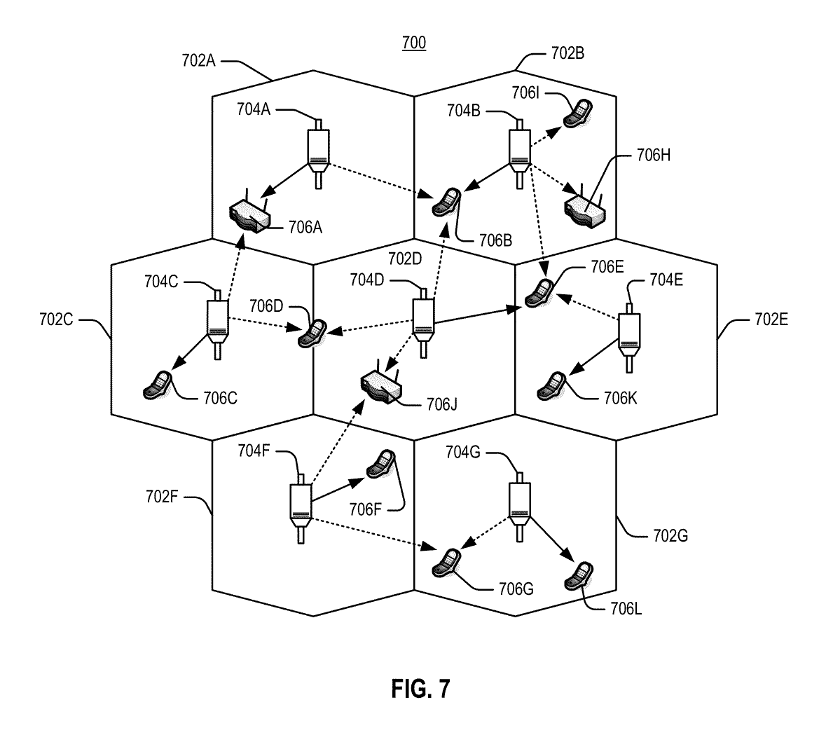

FIG. 7 illustrates a wireless communication system 700, configured to support a number of users, in which the teachings herein may be implemented. The system 700 provides communication for multiple cells 702, such as, for example, macrocells 702A-702G, with each cell being serviced by a corresponding access point 704 (e.g., access points 704A-704G). As shown in FIG. 7, access terminals 706 (e.g., access terminals 706A-706L) may be dispersed at various locations throughout the system over time. Each access terminal 706 may communicate with one or more access points 704 on a forward link (FL) and/or a reverse link (RL) at a given moment, depending upon whether the access terminal 706 is active and whether it is in soft handoff, for example. The wireless communication system 700 may provide service over a large geographic region. For example, macrocells 702A-702G may cover a few blocks in a neighborhood or several miles in a rural environment.

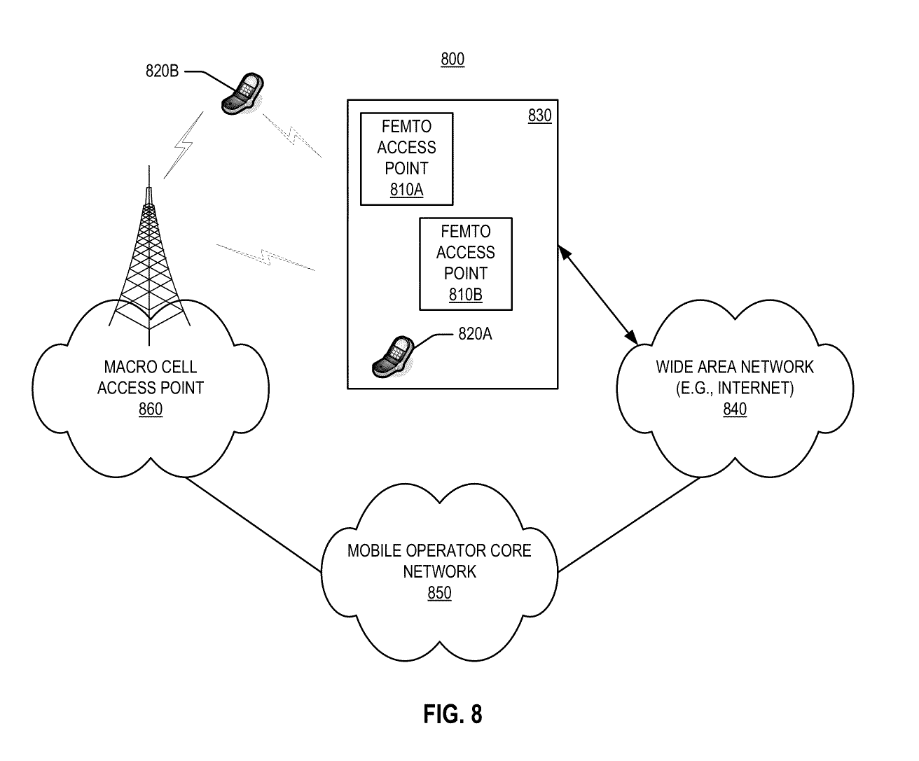

FIG. 8 illustrates an exemplary communication system 800 where one or more femto access points are deployed within a network environment. Specifically, the system 800 includes multiple femto access points 810 (e.g., femto access points 810A and 810B) installed in a relatively small scale network environment (e.g., in one or more user residences 830). Each femto access point 810 may be coupled to a wide area network 840 (e.g., the Internet) and a mobile operator core network 850 via a DSL router, a cable modem, a wireless link, or other connectivity means (not shown). As will be discussed below, each femto access point 810 may be configured to serve associated access terminals 820 (e.g., access terminal 820A) and, optionally, other (e.g., hybrid or alien) access terminals 820 (e.g., access terminal 820B). In other words, access to femto access points 810 may be restricted whereby a given access terminal 820 may be served by a set of designated (e.g., home) femto access point(s) 810 but may not be served by any non-designated femto access points 810 (e.g., a neighbor's femto access point 810).

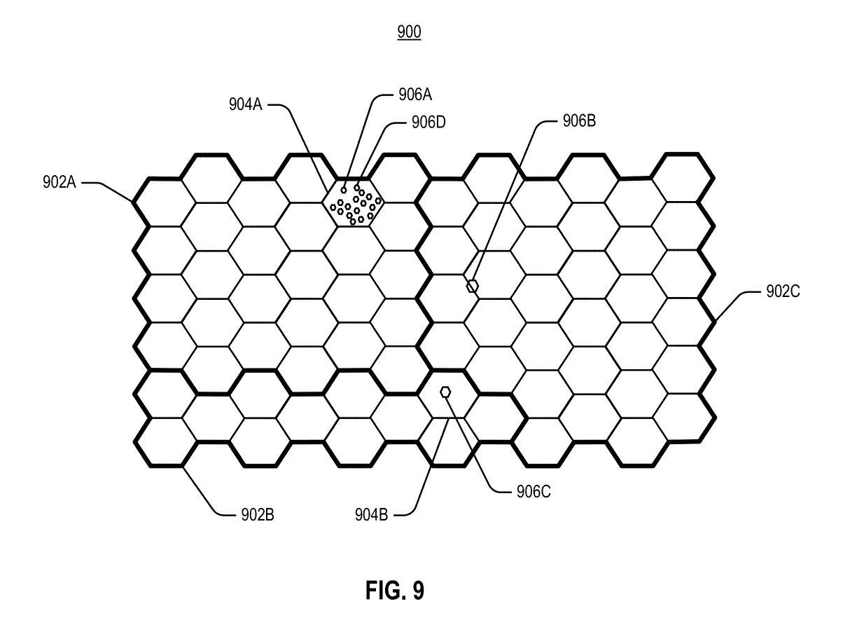

FIG. 9 illustrates an example of a coverage map 900 where several tracking areas 902 (or routing areas or location areas) are defined, each of which includes several macro coverage areas 904. Here, areas of coverage associated with tracking areas 902A, 902B, and 902C are delineated by the wide lines and the macro coverage areas 904 are represented by the larger hexagons. The tracking areas 902 also include femto coverage areas 906. In this example, each of the femto coverage areas 906 (e.g., femto coverage areas 906B and 906C) is depicted within one or more macro coverage areas 904 (e.g., macro coverage areas 904A and 904B). It should be appreciated, however, that some or all of a femto coverage area 906 might not lie within a macro coverage area 904. In practice, a large number of femto coverage areas 906 (e.g., femto coverage areas 906A and 906D) may be defined within a given tracking area 902 or macro coverage area 904. Also, one or more pico coverage areas (not shown) may be defined within a given tracking area 902 or macro coverage area 904.

Referring again to FIG. 8, the owner of a femto access point 810 may subscribe to mobile service, such as, for example, 3G mobile service, offered through the mobile operator core network 850. In addition, an access terminal 820 may be capable of operating both in macro environments and in smaller scale (e.g., residential) network environments. In other words, depending on the current location of the access terminal 820, the access terminal 820 may be served by a macrocell access point 860 associated with the mobile operator core network 850 or by any one of a set of femto access points 810 (e.g., the femto access points 810A and 810B that reside within a corresponding user residence 830). For example, when a subscriber is outside his home, he is served by a standard macro access point (e.g., access point 860) and when the subscriber is at home, he is served by a femto access point (e.g., access point 810A). Here, a femto access point 810 may be backward compatible with legacy access terminals 820.

A femto access point 810 may be deployed on a single frequency or, in the alternative, on multiple frequencies. Depending on the particular configuration, the single frequency or one or more of the multiple frequencies may overlap with one or more frequencies used by a macro access point (e.g., access point 860).

In some aspects, an access terminal 820 may be configured to connect to a preferred femto access point (e.g., the home femto access point of the access terminal 820) whenever such connectivity is possible. For example, whenever the access terminal 820A is within the user's residence 830, it may be desired that the access terminal 820A communicate only with the home femto access point 810A or 810B.

In some aspects, if the access terminal 820 operates within the macrocellular network 850 but is not residing on its most preferred network (e.g., as defined in a preferred roaming list), the access terminal 820 may continue to search for the most preferred network (e.g., the preferred femto access point 810) using a better system reselection (BSR) procedure, which may involve a periodic scanning of available systems to determine whether better systems are currently available and subsequently acquire such preferred systems. The access terminal 820 may limit the search for specific band and channel. For example, one or more femto channels may be defined whereby all femto access points (or all restricted femto access points) in a region operate on the femto channel(s). The search for the most preferred system may be repeated periodically. Upon discovery of a preferred femto access point 810, the access terminal 820 selects the femto access point 810 and registers on it for use when within its coverage area.

Access to a femto access point may be restricted in some aspects. For example, a given femto access point may only provide certain services to certain access terminals. In deployments with so-called restricted (or closed) access, a given access terminal may only be served by the macrocell mobile network and a defined set of femto access points (e.g., the femto access points 810 that reside within the corresponding user residence 830). In some implementations, an access point may be restricted to not provide, for at least one node (e.g., access terminal), at least one of: signaling, data access, registration, paging, or service.

In some aspects, a restricted femto access point (which may also be referred to as a Closed Subscriber Group Home NodeB) is one that provides service to a restricted provisioned set of access terminals. This set may be temporarily or permanently extended as necessary. In some aspects, a Closed Subscriber Group (CSG) may be defined as the set of access points (e.g., femto access points) that share a common access control list of access terminals.

Various relationships may thus exist between a given femto access point and a given access terminal. For example, from the perspective of an access terminal, an open femto access point may refer to a femto access point with unrestricted access (e.g., the femto access point allows access to any access terminal). A restricted femto access point may refer to a femto access point that is restricted in some manner (e.g., restricted for access and/or registration). A home femto access point may refer to a femto access point on which the access terminal is authorized to access and operate on (e.g., permanent access is provided for a defined set of one or more access terminals). A hybrid (or guest) femto access point may refer to a femto access point on which different access terminals are provided different levels of service (e.g., some access terminals may be allowed partial and/or temporary access while other access terminals may be allowed full access). An alien femto access point may refer to a femto access point on which the access terminal is not authorized to access or operate on, except for perhaps emergency situations (e.g., 911 calls).

From a restricted femto access point perspective, a home access terminal may refer to an access terminal that is authorized to access the restricted femto access point installed in the residence of that access terminal's owner (usually the home access terminal has permanent access to that femto access point). A guest access terminal may refer to an access terminal with temporary access to the restricted femto access point (e.g., limited based on deadline, time of use, bytes, connection count, or some other criterion or criteria). An alien access terminal may refer to an access terminal that does not have permission to access the restricted femto access point, except for perhaps emergency situations, for example, such as 911 calls (e.g., an access terminal that does not have the credentials or permission to register with the restricted femto access point).

For convenience, the disclosure herein describes various functionality in the context of a femto access point. It should be appreciated, however, that a pico access point may provide the same or similar functionality for a larger coverage area. For example, a pico access point may be restricted, a home pico access point may be defined for a given access terminal, and so on.

The teachings herein may be employed in a wireless multiple-access communication system that simultaneously supports communication for multiple wireless access terminals. Here, each terminal may communicate with one or more access points via transmissions on the forward and reverse links. The forward link (or downlink) refers to the communication link from the access points to the terminals, and the reverse link (or uplink) refers to the communication link from the terminals to the access points. This communication link may be established via a single-in-single-out system, a multiple-in-multiple-out (MIMO) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (TDD) and frequency division duplex (FDD). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

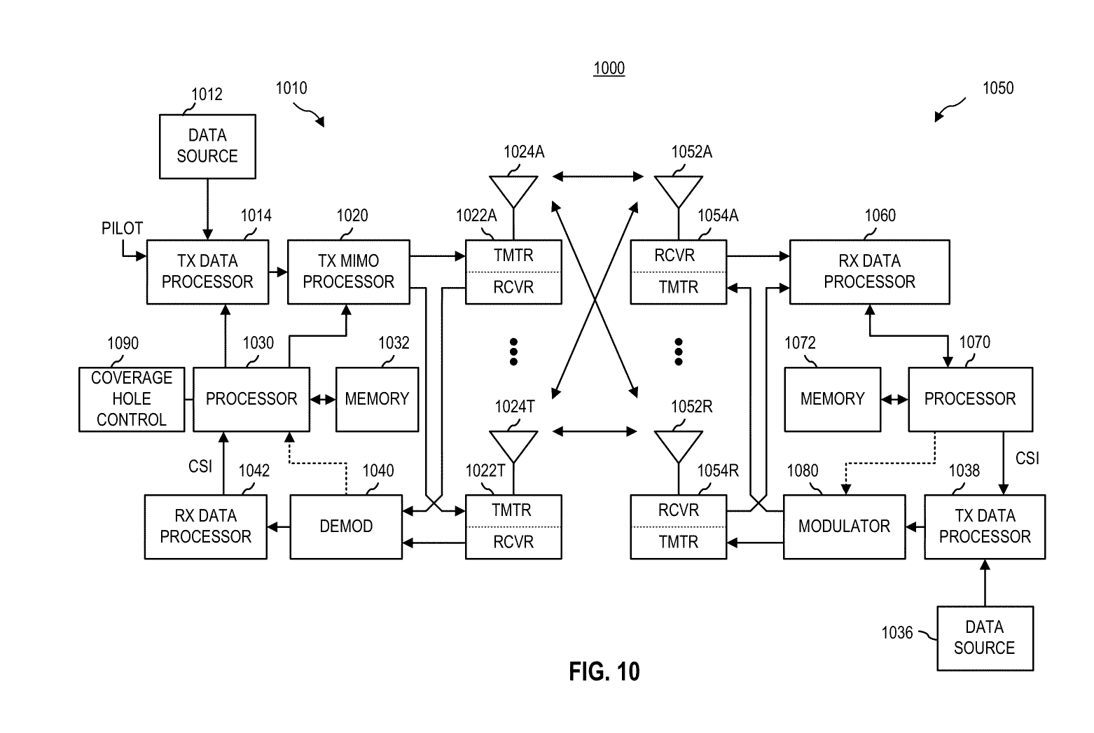

FIG. 10 illustrates a wireless device 1010 (e.g., an access point) and a wireless device 1050 (e.g., an access terminal) of a sample MIMO system 1000. At the device 1010, traffic data for a number of data streams is provided from a data source 1012 to a transmit (TX) data processor 1014. Each data stream may then be transmitted over a respective transmit antenna.

The TX data processor 1014 formats, codes, and interleaves the traffic data for each data stream based on a particular coding scheme selected for that data stream to provide coded data. The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 1030. A data memory 1032 may store program code, data, and other information used by the processor 1030 or other components of the device 1010.

The modulation symbols for all data streams are then provided to a TX MIMO processor 1020, which may further process the modulation symbols (e.g., for OFDM). The TX MIMO processor 1020 then provides N_{T} modulation symbol streams to N_{T} transceivers (XCVR) 1022A through 1022T. In some aspects, the TX MIMO processor 1020 applies beam-forming weights to the symbols of the data streams and to the antenna from which the symbol is being transmitted.

Each transceiver 1022 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 1022A through 1022T are then transmitted from N_{T} antennas 1024A through 1024T, respectively.

At the device 1050, the transmitted modulated signals are received by N_{R} antennas 1052A through 1052R and the received signal from each antenna 1052 is provided to a respective transceiver (XCVR) 1054A through 1054R. Each transceiver 1054 conditions (e.g., filters, amplifies, and downconverts) a respective received signal, digitizes the conditioned signal to provide samples, and further processes the samples to provide a corresponding “received” symbol stream.

A receive (RX) data processor 1060 then receives and processes the N_{R} received symbol streams from N_{R} transceivers 1054 based on a particular receiver processing technique to provide N_{T} “detected” symbol streams. The RX data processor 1060 then demodulates, deinterleaves, and decodes each detected symbol stream to recover the traffic data for the data stream. The processing by the RX data processor 1060 is complementary to that performed by the TX MIMO processor 1020 and the TX data processor 1014 at the device 1010.

A processor 1070 periodically determines which pre-coding matrix to use (discussed below). The processor 1070 formulates a reverse link message comprising a matrix index portion and a rank value portion. A data memory 1072 may store program code, data, and other information used by the processor 1070 or other components of the device 1050.

The reverse link message may comprise various types of information regarding the communication link and/or the received data stream. The reverse link message is then processed by a TX data processor 1038, which also receives traffic data for a number of data streams from a data source 1036, modulated by a modulator 1080, conditioned by the transceivers 1054A through 1054R, and transmitted back to the device 1010.

At the device 1010, the modulated signals from the device 1050 are received by the antennas 1024, conditioned by the transceivers 1022, demodulated by a demodulator (DEMOD) 1040, and processed by a RX data processor 1042 to extract the reverse link message transmitted by the device 1050. The processor 1030 then determines which pre-coding matrix to use for determining the beam-forming weights then processes the extracted message.

FIG. 10 also illustrates that the communication components may include one or more components that perform coverage hole control operations as taught herein. For example, a coverage hole control component 1090 may cooperate with the processor 1030 and/or other components of the device 1010 to manage coverage holes as taught herein. It should be appreciated that for each device 1010 and 1050 the functionality of two or more of the described components may be provided by a single component. For example, a single processing component may provide the functionality of the coverage hole control component 1090 and the processor 1030.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain aspects of the disclosure may be described using 3GPP terminology, it is to be understood that the teachings herein may be applied to 3GPP (e.g., Rel99, Rel5, Rel6, Rel7) technology, as well as 3GPP2 (e.g., 1xRTT, 1xEV-DO Rel0, RevA, RevB) technology and other technologies.

The teachings herein may be incorporated into (e.g., implemented within or performed by) a variety of apparatuses (e.g., nodes). In some aspects, a node (e.g., a wireless node) implemented in accordance with the teachings herein may comprise an access point or an access terminal.

For example, an access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations, an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macrocell, a macro node, a Home eNB (HeNB), a femtocell, a femto node, a pico node, or some other similar terminology.

In some aspects, a node (e.g., an access point) may comprise an access node for a communication system. Such an access node may provide, for example, connectivity for or to a network (e.g., a wide area network such as the Internet or a cellular network) via a wired or wireless communication link to the network. Accordingly, an access node may enable another node (e.g., an access terminal) to access a network or some other functionality. In addition, it should be appreciated that one or both of the nodes may be portable or, in some cases, relatively non-portable.

Also, it should be appreciated that a wireless node may be capable of transmitting and/or receiving information in a non-wireless manner (e.g., via a wired connection). Thus, a receiver and a transmitter as discussed herein may include appropriate communication interface components (e.g., electrical or optical interface components) to communicate via a non-wireless medium.

A wireless node may communicate via one or more wireless communication links that are based on or otherwise support any suitable wireless communication technology. For example, in some aspects a wireless node may associate with a network. In some aspects, the network may comprise a local area network or a wide area network. A wireless device may support or otherwise use one or more of a variety of wireless communication technologies, protocols, or standards such as those discussed herein (e.g., CDMA, TDMA, OFDM, OFDMA, WiMAX, Wi-Fi, and so on). Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a wireless node may comprise a wireless transceiver with associated transmitter and receiver components that may include various components (e.g., signal generators and signal processors) that facilitate communication over a wireless medium.

The functionality described herein (e.g., with regard to one or more of the accompanying figures) may correspond in some aspects to similarly designated “means for” functionality in the appended claims.

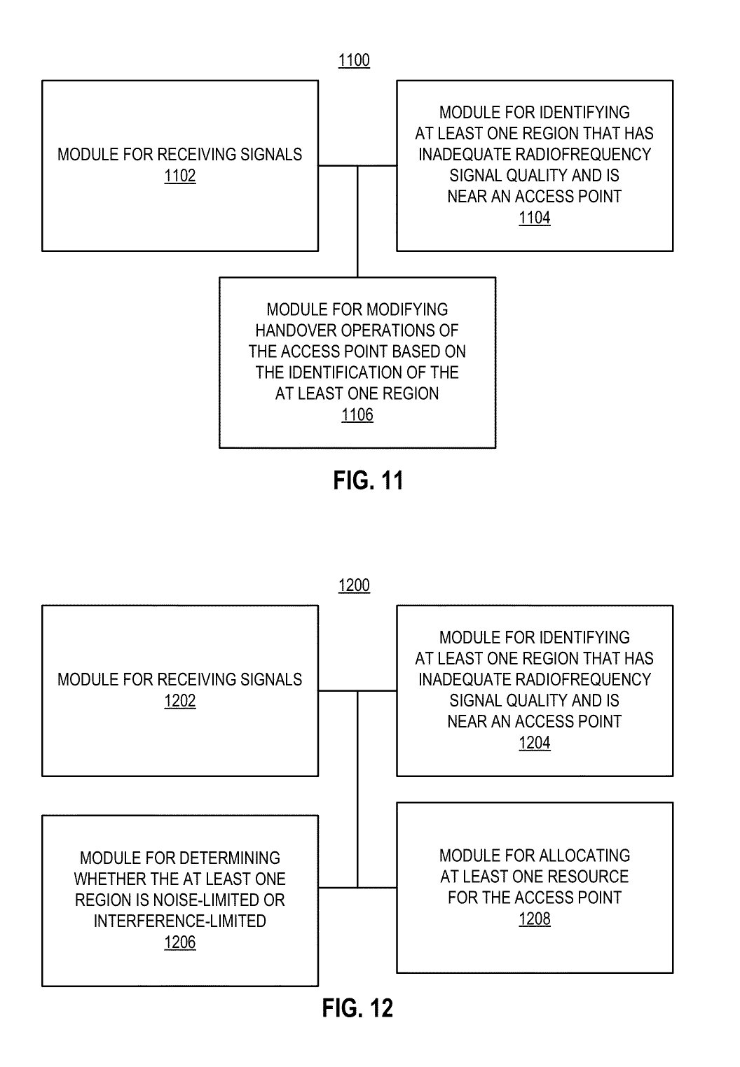

Referring to FIG. 11, an apparatus 1100 is represented as a series of interrelated functional modules. Here, a module for receiving signals 1102 may correspond at least in some aspects to, for example, a receiver as discussed herein. A module for identifying at least one region that has inadequate radiofrequency signal quality and is near an access point 1104 may correspond at least in some aspects to, for example, a processing system as discussed herein. A module for modifying handover operations of the access point based on the identification of the at least one region 1106 may correspond at least in some aspects to, for example, a processing system as discussed herein.

Referring to FIG. 12, an apparatus 1200 is represented as a series of interrelated functional modules. Here, a module for receiving signals 1202 may correspond at least in some aspects to, for example, a receiver as discussed herein. A module for identifying at least one region that has inadequate radiofrequency signal quality and is near an access point 1204 may correspond at least in some aspects to, for example, a processing system as discussed herein. A module for determining whether the at least one region is noise-limited or interference-limited 1206 may correspond at least in some aspects to, for example, a processing system as discussed herein. A module for allocating at least one resource for the access point 1208 may correspond at least in some aspects to, for example, a processing system as discussed herein.

The functionality of the modules of FIGS. 11 and 12 may be implemented in various ways consistent with the teachings herein. In some aspects, the functionality of these modules may be implemented as one or more electrical components. In some aspects, the functionality of these blocks may be implemented as a processing system including one or more processor components. In some aspects, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module. As one specific example, the apparatus 1100 may comprise a single device (e.g., components 1102-1106 comprising different sections of an ASIC). As another specific example, the apparatus 1100 may comprise several devices (e.g., the component 1102 comprising one ASIC and the components 1104-1106 comprising another ASIC). The functionality of these modules also may be implemented in some other manner as taught herein. In some aspects one or more of any dashed blocks in FIGS. 11 and 12 are optional.

In addition, the components and functions represented by FIGS. 11 and 12 as well as other components and functions described herein, may be implemented using any suitable means. Such means also may be implemented, at least in part, using corresponding structure as taught herein. For example, the components described above in conjunction with the “module for” components of FIGS. 11 and 12 also may correspond to similarly designated “means for” functionality. Thus, in some aspects one or more of such means may be implemented using one or more of processor components, integrated circuits, or other suitable structure as taught herein. Several examples follow. In some aspects, means for receiving comprises a receiver or a transceiver device. In some aspects, means for identifying comprises a processing system. In some aspects, means for modifying comprises a processing system. In some aspects, means for determining comprises a processing system. In some aspects, means for allocating comprises a processing system.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by a processing system, an integrated circuit (“IC”), an access terminal, or an access point. A processing system may be implemented using one or more ICs or may be implemented within an IC (e.g., as part of a system on a chip). An IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising code(s) executable (e.g., executable by at least one computer) to provide functionality relating to one or more of the aspects of the disclosure. In some aspects, a computer program product may comprise packaging materials.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A computer-readable media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer-readable medium (e.g., tangible media, computer-readable storage medium, computer-readable storage device, etc.). Such a non-transitory computer-readable medium (e.g., computer-readable storage device) may comprise any of the tangible forms of media described herein or otherwise known (e.g., a memory device, a media disk, etc.). In addition, in some aspects computer-readable medium may comprise transitory computer readable medium (e.g., comprising a signal). Combinations of the above should also be included within the scope of computer-readable media. It should be appreciated that a computer-readable medium may be implemented in any suitable computer-program product.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. An apparatus for communication, comprising:
a receiver configured to receive signals; and
a processing system configured to:
identify, based on the received signals, at least one region that has inadequate radiofrequency signal quality and is near an access point, and
modify handover operations of the access point based on the identification of the at least one region having inadequate radiofrequency signal quality.

2. The apparatus of claim 1, wherein the modification of handover operations comprises adjusting at least one handover parameter.

3. The apparatus of claim 2, wherein the at least one handover parameter comprises at least one CIO parameter and/or at least one Hyst parameter.

4. The apparatus of claim 1, wherein the modification of handover operations comprises adjusting a handover preference to increase a likelihood that handovers will be made to a specific type of cell.

5. The apparatus of claim 1, wherein the modification of handover operations comprises disabling measurement operations for at least one frequency.

6. The apparatus of claim 1, wherein:
the signals are received as a result of network listen measurements conducted by the access point; and
the identification of at least one region having inadequate radiofrequency signal quality comprises determining that measured signal quality corresponding to the received signals is less than or equal to at least one threshold signal strength.

7. The apparatus of claim 1, wherein:
the signals comprise a plurality of measurement report messages; and
the identification of at least one region having inadequate radiofrequency signal quality comprises:
identifying the at least one region based on the measurement report messages, and
determining that measured signal quality indications included in the measurement report messages are less than or equal to at least one threshold signal strength.

8. The apparatus of claim 1, wherein:
the signals comprise a plurality of handover messages; and
the identification of at least one region having inadequate radiofrequency signal quality comprises:
identifying the at least one region based on the handover messages,
identifying a type of handover associated with the handover messages, and
determining that a quantity of the handovers of the identified type over a defined period of time is greater than or equal to at least one threshold quantity.

9. The apparatus of claim 8, wherein:
the identified type of handover comprises a femtocell to femtocell handover; and
the modification of handover operations comprises adjusting a handover preference to increase a likelihood that handovers will be made to femtocells.

10. The apparatus of claim 8, wherein:
the identified type of handover comprises a macrocell to femtocell handover; and
the modification of handover operations comprises adjusting a handover preference to increase a likelihood that handovers will be made to macrocells.

11. The apparatus of claim 1, wherein:
the signals comprise a plurality of idle mode registration messages; and
the identification of at least one region having inadequate radiofrequency signal quality comprises:
identifying the at least one region based on the idle mode registration messages, and
determining that measured signal quality indications included in the idle mode registration messages are less than or equal to at least one threshold signal strength.

12. The apparatus of claim 1, wherein the apparatus is the access point.

13. The apparatus of claim 1, wherein the access point comprises a low-power access point.

14. A method of communication, comprising:
receiving signals;
identifying, based on the received signals, at least one region that has inadequate radiofrequency signal quality and is near an access point; and
modifying handover operations of the access point based on the identification of the at least one region having inadequate radiofrequency signal quality.

15. The method of claim 14, wherein the modification of handover operations comprises adjusting at least one handover parameter.

16. The method of claim 15, wherein the at least one handover parameter comprises at least one CIO parameter and/or at least one Hyst parameter.

17. The method of claim 14, wherein the modification of handover operations comprises adjusting a handover preference to increase a likelihood that handovers will be made to a specific type of cell.

18. The method of claim 14, wherein the modification of handover operations comprises disabling measurement operations for at least one frequency.

19. The method of claim 14, wherein:
the signals are received as a result of network listen measurements conducted by the access point; and
the identification of at least one region having inadequate radiofrequency signal quality comprises determining that measured signal quality corresponding to the received signals is less than or equal to at least one threshold signal strength.

20. The method of claim 14, wherein:
the signals comprise a plurality of measurement report messages; and
the identification of at least one region having inadequate radiofrequency signal quality comprises:
identifying the at least one region based on the measurement report messages, and
determining that measured signal quality indications included in the measurement report messages are less than or equal to at least one threshold signal strength.

21. The method of claim 14, wherein:
the signals comprise a plurality of handover messages; and
the identification of at least one region having inadequate radiofrequency signal quality comprises:
identifying the at least one region based on the handover messages,
identifying a type of handover associated with the handover messages; and
determining that a quantity of the handovers of the identified type over a defined period of time is greater than or equal to at least one threshold quantity.

22. The method of claim 21, wherein:
the identified type of handover comprises a femtocell to femtocell handover; and
the modification of handover operations comprises adjusting a handover preference to increase a likelihood that handovers will be made to femtocells.

23. The method of claim 21, wherein:
the identified type of handover comprises a macrocell to femtocell handover; and
the modification of handover operations comprises adjusting a handover preference to increase a likelihood that handovers will be made to macrocells.

24. The method of claim 14, wherein:
the signals comprise a plurality of idle mode registration messages; and
the identification of at least one region having inadequate radiofrequency signal quality comprises:
identifying the at least one region based on the idle mode registration messages, and
determining that measured signal quality indications included in the idle mode registration messages are less than or equal to at least one threshold signal strength.

25. The method of claim 14, wherein the method is performed at the access point.

26. The method of claim 14, wherein the access point comprises a low-power access point.

27. An apparatus for communication, comprising:
means for receiving signals;
means for identifying, based on the received signals, at least one region that has inadequate radiofrequency signal quality and is near an access point; and
means for modifying handover operations of the access point based on the identification of the at least one region having inadequate radiofrequency signal quality.

28. The apparatus of claim 27, wherein the modification of handover operations comprises adjusting at least one handover parameter.

29. The apparatus of claim 27, wherein the modification of handover operations comprises adjusting a handover preference to increase a likelihood that handovers will be made to a specific type of cell.

30. The apparatus of claim 27, wherein the modification of handover operations comprises disabling measurement operations for at least one frequency.

31. A computer-program product, comprising:
computer-readable medium comprising code for causing a computer to:
receive signals;
identify, based on the received signals, at least one region that has inadequate radiofrequency signal quality and is near an access point; and
modify handover operations of the access point based on the identification of the at least one region having inadequate radiofrequency signal quality.

32. The computer-program product of claim 31, wherein the modification of handover operations comprises adjusting at least one handover parameter.

33. The computer-program product of claim 31, wherein the modification of handover operations comprises adjusting a handover preference to increase a likelihood that handovers will be made to a specific type of cell.

34. The computer-program product of claim 31, wherein the modification of handover operations comprises disabling measurement operations for at least one frequency.

35. An apparatus for communication, comprising:
a receiver configured to receive signals; and
a processing system configured to:
identify, based on the received signals, at least one region that has inadequate radiofrequency signal quality and is near an access point,
determine, based on the received signals, whether the at least one region is noise-limited or interference-limited, and
allocate at least one resource for the access point based on the determination of whether the at least one region is noise-limited or interference-limited.

36. The apparatus of claim 35, wherein the determination of whether the at least one region is noise-limited or interference-limited comprises determining whether a total received signal strength associated with the received signals is substantially equal to a thermal noise floor.

37. The apparatus of claim 35, wherein the allocation of the at least one resource comprises adjusting a transmit power of the access point if the at least one region is noise-limited.

38. The apparatus of claim 35, wherein the allocation of the at least one resource comprises adjusting allocation of at least one resource block for the access point if the at least one region is noise-limited.

39. The apparatus of claim 38, wherein the at least one resource block comprises at least one frequency block and/or at least one time block.

40. The apparatus of claim 35, wherein the allocation of the at least one resource comprises, if the at least one region is interference-limited, adjusting allocation of at least one resource block for the access point without increasing transmit power of the access point.

41. The apparatus of claim 35, wherein:
the signals are received via a plurality of frequencies;
the at least one region comprises a plurality of regions, each of which is associated with a corresponding one of the frequencies; and
the at least one resource is allocated for transmissions by the access point on the plurality of frequencies.

42. The apparatus of claim 35, wherein:
the signals are received as a result of network listen measurements conducted by the access point; and
the identification of at least one region having inadequate radiofrequency signal quality comprises determining that measured signal quality corresponding to the received signals is less than or equal to at least one threshold signal quality.

43. The apparatus of claim 35, wherein the radiofrequency signal quality comprises signal strength, CPICH E_{C}/I₀, or RSSI.

44. The apparatus of claim 35, wherein:
the signals comprise a plurality of measurement report messages; and
the identification of at least one region having inadequate radiofrequency signal quality comprises:
identifying the at least one region based on the measurement report messages, and
determining that measured signal quality indications included in the measurement report messages are less than or equal to at least one threshold signal quality.

45. The apparatus of claim 35, wherein:
the signals comprise a plurality of handover messages; and
the identification of at least one region having inadequate radiofrequency signal quality comprises:
identifying the at least one region based on the handover messages,
identifying a type of handover associated with the handover messages; and
determining that a quantity of the handovers of the identified type over a defined period of time is greater than or equal to at least one threshold quantity.

46. The apparatus of claim 45, wherein the handover messages comprise:
measurement report messages sent from a source cell to a target cell; or
information elements containing access terminal history information.

47. The apparatus of claim 45, wherein the identified type of handover comprises a femtocell to femtocell handover or a macrocell to femtocell handover.

48. The apparatus of claim 35, wherein:
the signals comprise a plurality of idle mode registration messages; and
the identification of at least one region having inadequate radiofrequency signal quality comprises:
identifying the at least one region based on the idle mode registration messages, and
determining that measured signal quality indications included in the idle mode registration messages are less than or equal to at least one threshold signal strength.

49. The apparatus of claim 35, wherein the apparatus is the access point.

50. The apparatus of claim 35, wherein the access point comprises a low-power access point.

51. A method of communication, comprising:
receiving signals;
identifying, based on the received signals, at least one region that has inadequate radiofrequency signal quality and is near an access point;
determining, based on the received signals, whether the at least one region is noise-limited or interference-limited; and
allocating at least one resource for the access point based on the determination of whether the at least one region is noise-limited or interference-limited.

52. The method of claim 51, wherein the determination of whether the at least one region is noise-limited or interference-limited comprises determining whether a total received signal strength associated with the received signals is substantially equal to a thermal noise floor.

53. The method of claim 51, wherein the allocation of the at least one resource comprises adjusting a transmit power of the access point if the at least one region is noise-limited.

54. The method of claim 51, wherein the allocation of the at least one resource comprises adjusting allocation of at least one resource block for the access point if the at least one region is noise-limited.

55. The method of claim 54, wherein the at least one resource block comprises at least one frequency block and/or at least one time block.

56. The method of claim 51, wherein the allocation of the at least one resource comprises, if the at least one region is interference-limited, adjusting allocation of at least one resource block for the access point without increasing transmit power of the access point.

57. The method of claim 51, wherein:
the signals are received via a plurality of frequencies;
the at least one region comprises a plurality of regions, each of which is associated with a corresponding one of the frequencies; and
the at least one resource is allocated for transmissions by the access point on the plurality of frequencies.

58. The method of claim 51, wherein:
the signals are received as a result of network listen measurements conducted by the access point; and
the identification of at least one region having inadequate radiofrequency signal quality comprises determining that measured signal quality corresponding to the received signals is less than or equal to at least one threshold signal quality.

59. The method of claim 51, wherein the radiofrequency signal quality comprises signal strength, CPICH E_{C}/I₀, or RSSI.

60. The method of claim 51, wherein:
the signals comprise a plurality of measurement report messages; and
the identification of at least one region having inadequate radiofrequency signal quality comprises:
identifying the at least one region based on the measurement report messages, and
determining that measured signal quality indications included in the measurement report messages are less than or equal to at least one threshold signal quality.

61. The method of claim 51, wherein:
the signals comprise a plurality of handover messages; and
the identification of at least one region having inadequate radiofrequency signal quality comprises:
identifying the at least one region based on the handover messages,
identifying a type of handover associated with the handover messages; and
determining that a quantity of the handovers of the identified type over a defined period of time is greater than or equal to at least one threshold quantity.

62. The method of claim 61, wherein the handover messages comprise:
measurement report messages sent from a source cell to a target cell; or
information elements containing access terminal history information.

63. The method of claim 61, wherein the identified type of handover comprises a femtocell to femtocell handover or a macrocell to femtocell handover.

64. The method of claim 51, wherein:
the signals comprise a plurality of idle mode registration messages; and
the identification of at least one region having inadequate radiofrequency signal quality comprises:
identifying the at least one region based on the idle mode registration messages, and
determining that measured signal quality indications included in the idle mode registration messages are less than or equal to at least one threshold signal strength.

65. The method of claim 51, wherein the method is performed at the access point.

66. The method of claim 51, wherein the access point comprises a low-power access point.

67. An apparatus for communication, comprising:
means for receiving signals;
means for identifying, based on the received signals, at least one region that has inadequate radiofrequency signal quality and is near an access point;
means for determining, based on the received signals, whether the at least one region is noise-limited or interference-limited; and
means for allocating at least one resource for the access point based on the determination of whether the at least one region is noise-limited or interference-limited.

68. The apparatus of claim 67, wherein the determination of whether the at least one region is noise-limited or interference-limited comprises determining whether a total received signal strength associated with the received signals is substantially equal to a thermal noise floor.

69. The apparatus of claim 67, wherein the allocation of the at least one resource comprises adjusting a transmit power of the access point if the at least one region is noise-limited.

70. The apparatus of claim 67, wherein the allocation of the at least one resource comprises adjusting allocation of at least one resource block for the access point if the at least one region is noise-limited.

71. The apparatus of claim 67, wherein the allocation of the at least one resource comprises, if the at least one region is interference-limited, adjusting allocation of at least one resource block for the access point without increasing transmit power of the access point.

72. A computer-program product, comprising:
computer-readable medium comprising code for causing a computer to:
receive signals;
identify, based on the received signals, at least one region that has inadequate radiofrequency signal quality and is near an access point,
determine, based on the received signals, whether the at least one region is noise-limited or interference-limited, and
allocate at least one resource for the access point based on the determination of whether the at least one region is noise-limited or interference-limited.

73. The computer-program product of claim 72, wherein the determination of whether the at least one region is noise-limited or interference-limited comprises determining whether a total received signal strength associated with the received signals is substantially equal to a thermal noise floor.

74. The computer-program product of claim 72, wherein the allocation of the at least one resource comprises adjusting a transmit power of the access point if the at least one region is noise-limited.

75. The computer-program product of claim 72, wherein the allocation of the at least one resource comprises adjusting allocation of at least one resource block for the access point if the at least one region is noise-limited.

76. The computer-program product of claim 72, wherein the allocation of the at least one resource comprises, if the at least one region is interference-limited, adjusting allocation of at least one resource block for the access point without increasing transmit power of the access point.
